(19) United States
(12) Patent Application Publication
(10) Pub. No.: US 2010/0023741 A1
(43) Pub. Date: Jan. 28, 2010

(54) METHOD FOR SETTING BIOS AND RECREATING CHECKSUM VALUE

(75) Inventor: ZHEN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/240,027

(22) Filed: Sep. 29, 2008

(30) Foreign Application Priority Data
Jul. 23, 2008 (CN) 200810302959.5

(51) Int. Cl. G06F 9/445

(52) U.S. Cl. 713/2

(57) ABSTRACT

A method is used for setting a basic input output system (BIOS) and recreating a checksum value in a computer. The BIOS is stored in a complementary metal-oxide semiconductor (CMOS). The method includes modifying an original BIOS value to a new BIOS value, writing a preset value into a setting storage unit of the CMOS, checking a value in the setting storage unit against the preset value, recreating a new checksum value based on the new BIOS value, overwriting an original checksum value with the new checksum value, and clearing the setting storage unit. The checking and the recreating steps are executed before a BIOS checksum validation of the computer during a computer initialization process when the computer is restarted.

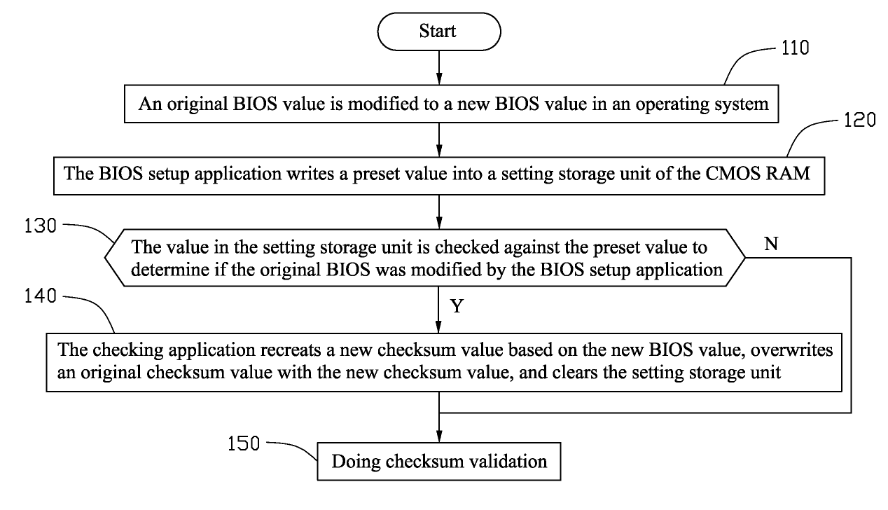

### BACKGROUND

1. Technical Field

The present invention relates to a method for setting a basic input output system (BIOS) and recreating a checksum value in computers.

2. Description of Related Art

In computing, BIOS is a type of boot loader referring to a firmware code run by a personal computer (PC) when the PC is first powered on. The primary function of the BIOS is to identify and initialize system component hardware, such as a video display card, a hard disk, and a floppy drive.

When a computer is powered on, the BIOS performs a power-on self test (POST), to make sure every component is connected and functioning. Before the POST routine is performed, a checksum, which is computed as an error-detecting code, is recomputed based on the present BIOS and checked against a stored checksum value to perform a validation. If they do not match, an error message is generated to alert users that a complementary metal-oxide semiconductor (CMOS) random access memory (RAM) which stores the checksum value contents may have been corrupted and therefore some settings may be wrong. However, the BIOS will assume that the settings that were in the CMOS RAM were corrupted and will load default values stored in the BIOS chip for safety reasons.

What is needed, therefore, is a method for setting BIOS and recreating checksum values based on the set BIOS in computers.

### BRIEF DESCRIPTION OF THE DRAWINGS

The drawing is a block diagram of an embodiment of a method for setting BIOS and recreating a checksum value.

### DETAILED DESCRIPTION

The drawing is a flowchart utilizing a method for setting BIOS and recreating a checksum value before a BIOS checksum validation of a computer during the computer initialization process. Depending on the embodiment, certain of the steps described below may be removed, others may be added, and the sequence of steps may be altered.

In a step 110, the original BIOS value is modified to a new BIOS value in an operating system by a BIOS setup application. The operating system may be DOS, Windows series, Mac, Linux or the like. The new BIOS value and the original BIOS value are stored in a CMOS RAM.

Continuing to a step 120, in order for the new BIOS to be recognized by the computer set by the BIOS setup application, the BIOS setup application writes a preset value into a setting storage unit of the CMOS RAM as identification. In one embodiment, the preset value is 0×7E. In other embodiments, the BIOS setup application may be stored in a remote computer, a hard disk of the computer, or embedded in the CMOS RAM. In one embodiment, the setting storage unit can hold at least 1 byte.

Moving to a step 130, the computer is restarted, and the value in the setting storage unit is checked against the preset value by a checking application to determine if the original BIOS was modified by the BIOS setup application. In one embodiment, the checking application may be embedded in the CMOS RAM and may be integrated into the BIOS setup application. If the values are not matching, the original BIOS was not modified by the BIOS setup application, the method continues to a step 150. If the values are matching, the method continues to a step 140.

In the step 140, the checking application recreates a new checksum value based on the new BIOS value, overwrites an original checksum value with the new checksum value in the CMOS RAM before the BIOS checksum validation of the computer, and clears the setting storage unit. The original checksum value was created based on the original BIOS value. The method continues to step 150.

In the step 150, the computer will do checksum validation and do POST directly.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for setting a basic input output system (BIOS) stored in a complementary metal-oxide semiconductor (CMOS) and recreating a checksum value in a computer, the method comprising:
modifying an original BIOS value to a new BIOS value;
writing a preset value into a setting storage unit of the CMOS;
checking a value in the setting storage unit against the preset value;
in response to determining that the value in the setting storage unit matches the preset value, recreating a new checksum value based on the new BIOS value, overwriting an original checksum value with the new checksum value, and clearing the setting storage unit;
wherein checking a value and recreating a new checksum value are executed before a BIOS checksum validation of the computer during a computer initialization process when the computer is restarted.

2. The method of claim 1, wherein the original BIOS value is modified by a BIOS setup application in an operating system; the operating system is a system selected from the group consisting of DOS, Windows, Mac, and Linux.

3. The method of claim 2, wherein the BIOS setup application is stored in a location selected from the group consisting of a hard disk of the computer and the CMOS.

4. The method of claim 1, wherein the original BIOS value is modified by a remote computer.

5. The method of claim 1, wherein the value in the setting storage unit is checked by a checking application, the checking application is embedded in the CMOS.

6. The method of claim 4, wherein the new checksum value is recreated by the checking application.

7. The method of claim 1, wherein the setting storage unit is capable of holding at least one byte.

8. The method of claim 1, wherein the original checksum value is created based on the original BIOS value.

9. A method for setting a BIOS value stored in a CMOS of a motherboard and recreating a checksum value before a BIOS checksum validation of a computer during a computer initialization process, the method comprising:
checking a value in a setting storage unit of the CMOS against a preset value to determine if a previous BIOS value of the computer has been modified by a BIOS setup application;
in response to the value in the setting storage unit matching the preset value, recreating a new checksum value based on a modified BIOS value, and overwriting a previous checksum value with the new checksum value; and
clearing the setting storage unit.

10. The method of claim 9, wherein the previous BIOS value is modified in an operating system, the operating system is a system selected from the group consisting of DOS, Windows, Mac, and Linux.

11. The method of claim 9, wherein the previous BIOS value is modified by the BIOS setup application from a remote computer.

12. The method of claim 9, wherein the BIOS setup application is stored in a location selected from the group consisting of a hard disk of the computer and the CMOS.

13. The method of claim 9, wherein the value in the setting storage unit is checked by a checking application, the checking application is embedded in the CMOS.

14. The method of claim 13, wherein the new checksum value is recreated by the checking application.

15. The method of claim 9, wherein the setting storage unit is capable of holding at least one byte.

16. The method of claim 9, wherein the previous checksum value is created based on the previous BIOS value.
